(19) United States
(12) Patent Application Publication
(10) Pub. No.: US 2006/0053922 A1
(43) Pub. Date: Mar. 16, 2006

(54) Lubrication system for supplying lubricant between intermeshing gear teeth

(76) Inventor: Erich A. Laabs, McHenry, IL (US)

Correspondence Address: DAVID J. ARCHER, 7037 POMERY ROAD, ROCKTON, IL, 61072, US

(21) Appl. No.: 11/216,528

(22) Filed: Aug. 31, 2005

Related U.S. Application Data
(60) Provisional application No. 60/607,104, filed on Sep. 3, 2004.

(51) Int. Cl. F16H 57/04

(52) U.S. Cl. 74/467

(57) ABSTRACT

In a gear apparatus having intermeshing gear teeth, a lubrication system is disclosed for supplying lubricant between the intermeshing gear teeth. The lubrication system includes a gear defining an internal cavity which is connected to a source of the lubricant. The gear defines a plurality of spaced circumferentially disposed gear teeth. The plurality of gear teeth include a first gear tooth and a second gear tooth disposed adjacent to the first gear tooth. The gear defines a channel having a first and a second end. The first end of the channel is connected to the internal cavity. The second end of the channel is disposed between the first and second gear teeth. The arrangement is such that when the internal cavity is connected to the source of the lubricant, lubricant flows from the cavity through the first end of the channel to the second end of the channel for distributing the lubricant between the adjacent gear teeth so that the intermeshing gear teeth are lubricated.

### CROSS REFERENCE TO RELATED APPLICATION

This application is a Complete application to Provisional patent application U.S. Ser. No. 60/607,104 filed Sep. 3, 2004. All the disclosure of the aforementioned Provisional application is incorporated herein by reference.

### BACKGROUND OF THE INVENTION

1. Field of the Invention

The present invention relates to a lubrication system for supplying lubricant between intermeshing gear teeth.

More specifically, the present invention relates to a lubrication system for supplying lubricant between intermeshing gear teeth of gears for driving a dryer section of a papermaking machine.

2. Background Information

In the papermaking industry, a web of pressed paper is dried by guiding the web around a plurality of rotating internally heated drying cylinders. Each of such drying cylinders typically has a diameter of 6 feet and a width of up to 40 feet. The drying cylinders are rotated so that the dried web is guided around such drying cylinders at speeds of up to 10,000 feet per minute. Consequently, the gears for driving such drying cylinders must be designed to withstand the considerable stress imposed upon the driving gear train.

Intermeshing gear teeth of the dryer gear train are typically supplied with lubricating oil by various drip feed arrangements such lubricant being supplied externally between intermeshing teeth. Excess lubricant is collected at the bottom of a gear casing enclosure for filtering and recirculation of the lubricant.

While the aforementioned prior art lubricating system has proved adequate for most slower running machines, there has been a tendency in recent years to greatly increase the speed of rotation of the drying cylinders. More specifically, in order to increase the rate of production of paper, the width of the drying cylinder can be increased and also, the speed of rotation of the drying cylinders can be increased. However, a practical limit to the width of the drying cylinder has already been reached. The support of a rotating cylinder nearly 40 foot in width already presents problems in engineering particularly due to central deflection of the rotating drying cylinder. Accordingly, dryer speeds have been increased due to the aforementioned limitation on dryer cylinder width. Such speed increase imposes greater strain on the intermeshing gear teeth and the present invention provides a unique and improved arrangement for supplying lubricant internally through the gear wheel for supplying a flow of lubricant directly between intermeshing gear teeth.

Therefore, a primary feature of the present invention is the provision of a lubrication system for internally supplying lubricant between intermeshing gear teeth that overcomes the problems associated with the prior art arrangements.

Another feature of the present invention is the provision of a lubrication system for supplying lubricant between intermeshing gear teeth that extends the life of the intermeshing gear teeth.

A further feature of the present invention is the provision of a method of manufacturing a gear including a lubrication system according to the present invention for supplying lubricant between the intermeshing gear teeth.

Other features and advantages of the present invention will be readily apparent to those skilled in the art by a consideration of the detailed description of a preferred embodiment of the present invention contained herein.

### SUMMARY OF THE INVENTION

In a gear apparatus having intermeshing gear teeth, the present invention relates to a lubrication system for supplying lubricant between the intermeshing gear teeth. The lubrication system includes a gear defining an internal cavity which is connected to a source of the lubricant. The gear defines a plurality of spaced circumferentially disposed gear teeth. The plurality of gear teeth include a first gear tooth and a second gear tooth disposed adjacent to the first gear tooth. The gear defines a channel having a first and a second end. The first end of the channel is connected to the internal cavity. The second end of the channel is disposed between the first and second gear teeth. The arrangement is such that when the internal cavity is connected to the source of the lubricant, lubricant flows from the cavity through the first end of the channel to the second end of the channel for distributing the lubricant between the adjacent gear teeth so that the intermeshing gear teeth are lubricated.

In a more specific aspect of the present invention, the gear is a gear wheel for driving a dryer of a paper making machine.

More specifically, the gear includes a hub which defines an axial bore. An intermediate portion is disposed coaxially around the hub. A peripheral portion is disposed coaxially around the intermediate portion, the peripheral portion having an outer surface. The outer surface of the peripheral portion defines the plurality of gear teeth such that the plurality of gear teeth extend outwardly away from the hub.

Also, an elongate shaft has a first and a second extremity, the shaft extending coaxially through the axial bore of the hub such that the gear is bearingly supported by the shaft for rotation of the gear relative to the shaft.

More specifically, the shaft includes a first bearing which is disposed coaxially around the shaft. The first bearing is disposed between the first and second extremities of the shaft such that the first bearing cooperates with the axial bore of the hub for supporting the hub relative to the shaft. A second bearing is disposed coaxially around the shaft. The second bearing is disposed between the first and second extremities of the shaft and is spaced axially from the first bearing such that the second bearing cooperates with the axial bore of the hub for supporting the hub relative to the shaft.

Additionally, the shaft defines a conduit having a termination which is disposed adjacent to the hub, the termination being disposed between the first and second bearings. The conduit extends through the shaft towards the hub for supplying the lubricant from the source of the lubricant to the hub. The arrangement is such that lubricant flows from at least one of the extremities of the shaft through the conduit towards the termination of the conduit.

Also, the shaft defines a cross bore which extends from the termination of the conduit so that the flow of lubricant is guided from the termination through the cross bore into the axial bore of the hub.

Moreover, the shaft further includes a first flange which is secured to the first extremity of the shaft. A second flange is secured to the second extremity of the shaft.

Furthermore, the internal cavity is of disc shaped configuration. The cavity extends coaxially within the intermediate portion for permitting flow of lubricant outwardly from the axial bore of the hub through the disc shaped cavity towards the peripheral portion.

The disc shaped cavity permits flow of lubricant outwardly therethrough by centrifugal force from the axial bore of the hub to the channel so that lubricant is supplied centrifugally through the channel for lubricating the intermeshing gear teeth.

The present invention also includes a method of manufacturing a gear of a lubrication system. The method includes the step of casting the gear as a metal casting.

More specifically, the step of casting the gear includes the substeps of generating a first foam pattern of a first side of the gear, the first side of the gear having a first side of the hub, intermediate portion, peripheral portion and plurality of gear teeth.

The substep also includes generating a second foam pattern of a second side of the gear, the second side of the gear having a second side of the hub, intermediate portion, peripheral portion and plurality of gear teeth.

The substep next includes generating a third foam pattern of a gear ring of the gear, the gear ring defining a part of the plurality of gear teeth. The third pattern also defines a coaxial disc shaped cavity. The third foam pattern defines on at least one side thereof a notch which is disposed between adjacent parts of the gear teeth.

The first, second and third foam patterns are coaxially aligned such that the third foam pattern is disposed between the first and second patterns.

The combined foam patterns are next placed within a casting box.

The casting box is filled with casting sand mixed with resin such that the sand fills the cavity and the notch and so that the sand surrounds the combined patterns.

Molten metal is then poured into the casting box such that the cast metal burns the foam patterns to generate a cast metal gear.

The sand around the cast metal gear is then removed and the sand disposed within the disc shaped cavity and the notch are removed so that the cast metal gear defines a corresponding disc shaped cavity and a channel corresponding to the notch. The arrangement is such that in use of the cast metal gear, lubricant flows centrifugally from the axial bore of the hub through the disc shaped cavity and through the channel for lubricating intermeshing teeth of the cast metal gear.

More specifically, the step of generating the third foam pattern includes forming the third foam pattern so that it defines a first notch on a first side of the third foam pattern, the first notch being disposed between adjacent teeth.

The third foam pattern is also formed such that it defines a second notch on a second side of the third foam pattern. The second notch is disposed between adjacent teeth so that the resultant cast metal gear defines a corresponding first and second channel between adjacent gear teeth. The channels are spaced axially relative to each other.

An alternative method includes the further step of generating a fourth foam pattern similar in shape to the third pattern so that when the patterns are combined, the fourth pattern is disposed between the third and second patterns. The arrangement is such that the resultant cast metal gear defines corresponding first, second and third channels between adjacent gear teeth, the channels being spaced axially relative to each other.

In another method, the step of generating the first foam pattern includes forming a cut out for alignment with the notch of the third portion so that the combined cut out and notch correspond with the resultant channel.

Also, the step of forming the second foam pattern includes forming a groove for alignment with the second notch of the third portion so that the combined groove and second notch: correspond with the resultant second channel.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of a gear apparatus having intermeshing gear teeth according to the present invention;

FIG. 2 is an enlarged perspective view partially in section of one of the gears shown in FIG. 1.

FIG. 3 is an enlarged view taken on the line 3-3 of FIG. 2.

FIG. 4 is a perspective view of the gear shown in FIGS. 1-3;

FIG. 5 is a similar view to that shown in FIG. 4 but shows a shaft assembled within the hub of the gear;

FIG. 6 is a sectional view taken on the line 6-6 of FIG. 5;

FIG. 7 is a perspective view of a first foam pattern used in the step of casting the gear shown in FIGS. 1-6;

FIG. 8 is a side elevational view showing a casting box:

FIG. 9 is a similar view to that shown in FIG. 8 but shows the next substep of filling the casting box with casting sand mixed with resin;

FIG. 10 is a similar view to that shown in FIG. 9 but shows the next substep of pouring molten metal into the casting box;

FIG. 11 is an enlarged view taken on the line 11-11 of FIG. 7;

FIG. 12 is perspective view of an alternative method of fabricating a gear 16; and

FIG. 13 is a similar view to that shown in FIG. 12 but shows another method of fabricating a gear according to the present invention.

Similar reference characters refer to similar parts throughout the various views of the drawings.

### DETAILED DESCRIPTION OF THE DRAWINGS

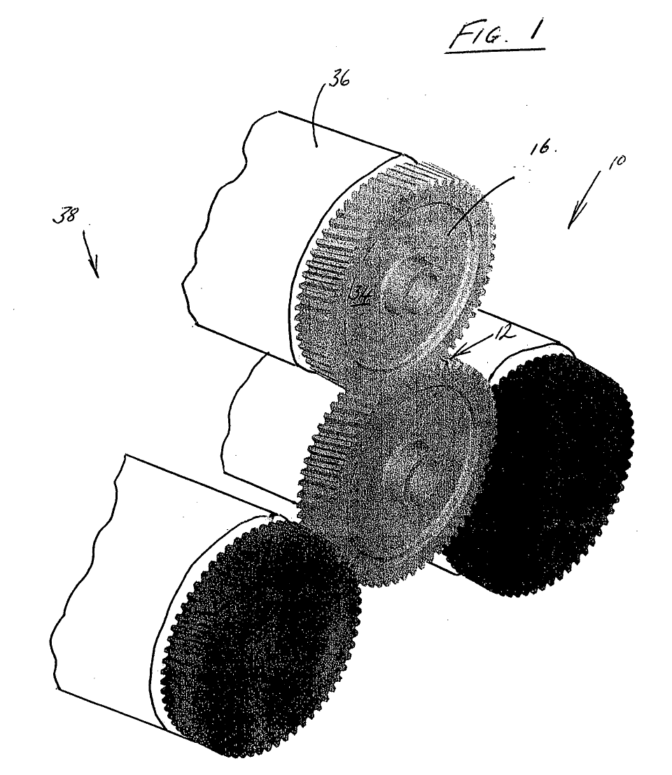

FIG. 1 is a perspective view of a gear apparatus generally designated 10 having intermeshing gear teeth generally designated 12.

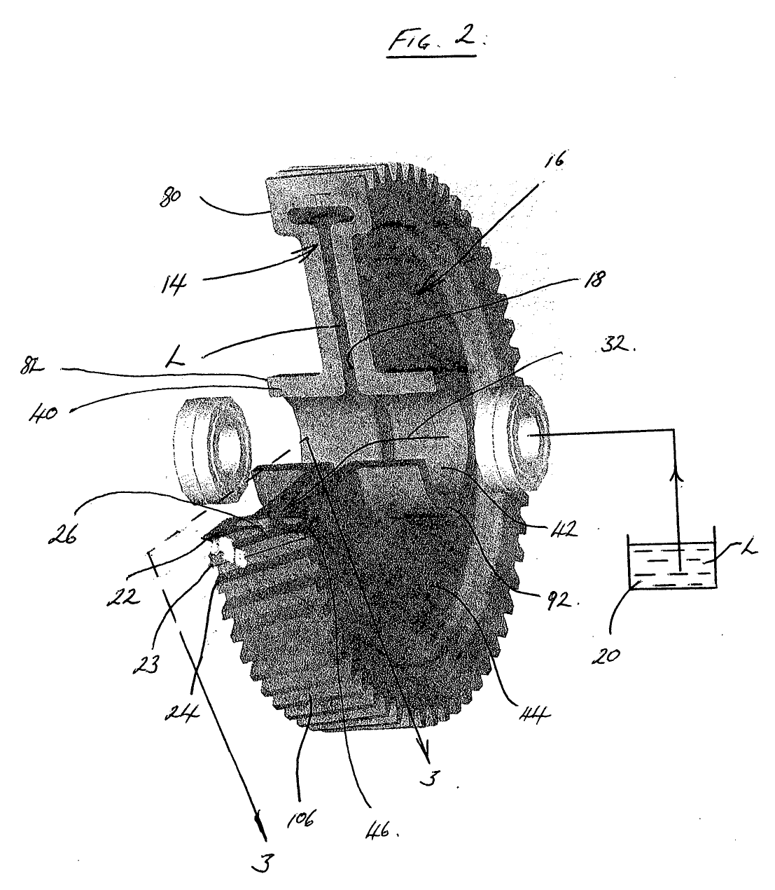

FIG. 2 is an enlarged perspective view partially in section of one of the gears shown in FIG. 1. As shown in FIG. 2, the present invention relates to a lubrication system generally designated 14 for supplying lubricant L between the intermeshing gear teeth 12 shown in FIG. 1. The lubrication system 14 includes a gear generally designated 16.

The gear 16 defines an internal cavity 18 which is connected to a source 20 of the lubricant L. The gear 16 defines a plurality of spaced circumferentially disposed gear teeth 22, 23 and 24. The plurality of gear teeth 22-24 include a first gear tooth 22 and a second gear tooth 23 disposed adjacent to the first gear tooth 22. The gear 16 defines a channel 26.

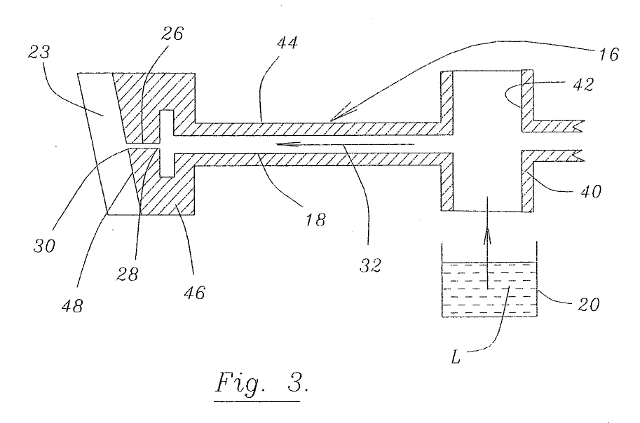

FIG. 3 is an enlarged view taken on the line 3-3 of FIG. 2. As shown in FIG. 3, the channel 26 has a first and a second end 28 and 30 respectively. The first end 28 of the channel 26 is connected to the internal cavity 18. The second end 30 of the channel 26 is disposed between the first tooth 22 and the second gear tooth 23 as shown in FIGS. 1 and 2. The arrangement is such that when the internal cavity 18 is connected to the source 20 of the lubricant L, lubricant L flows as indicated by the arrow 32 from the cavity 18 through the first end 28 of the channel 26 to the second end 30 of the channel 26 for distributing the lubricant L between the adjacent gear teeth 22 and 23 respectively so that the intermeshing gear teeth 12 are lubricated as shown in FIG. 1.

As shown in FIG. 1, in a more specific aspect of the present invention, the gear 16 is a driven gear wheel 34 for driving a dryer 36 of a dryer section of a paper making machine generally designated 38.

As shown in FIG. 3, the gear 16 includes a hub 40 which defines an axial bore 42. An intermediate portion 44 is disposed coaxially around the hub 40. A peripheral portion 46 is disposed coaxially around the intermediate portion 44, the peripheral portion 46 having an outer surface 48. The outer surface 48 of the peripheral portion 46 defines the plurality of teeth 22-24 shown in FIGS. 1 and 2 such that the plurality of gear teeth 22-24 extend outwardly away from the hub 40.

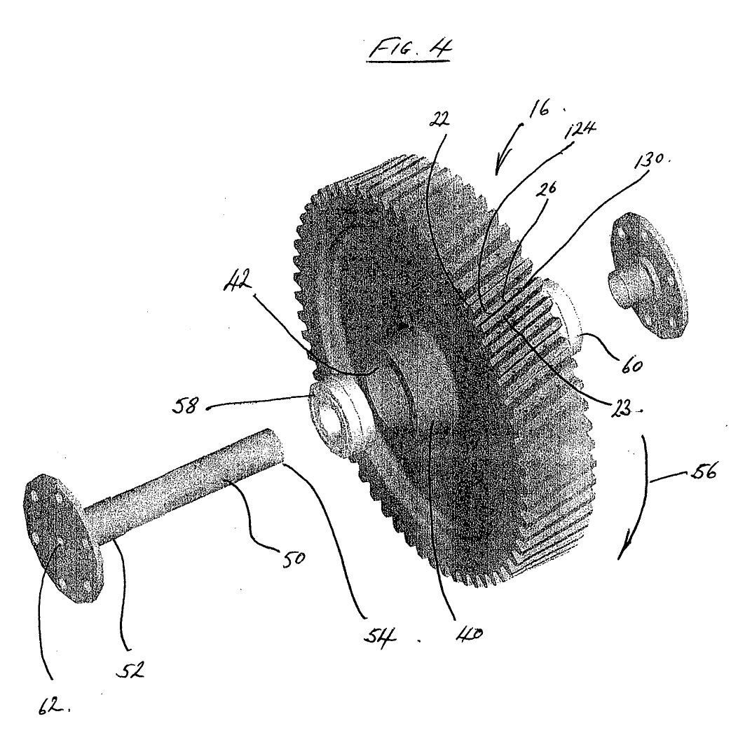

FIG. 4 is a perspective view of the gear 16 shown in FIGS. 1-3. As shown in FIG. 4, an elongate shaft 50 has a first and a second extremity 52 and 54 respectively. The shaft 50 extends coaxially through the axial bore 42 of the hub 40 such that the gear 16 is bearingly supported by the shaft 50 for rotation of the gear 16 relative to the shaft 50 as indicated by the arrow 56.

More specifically, as shown in FIG. 4, the shaft 50 includes a first bearing 58 which is disposed coaxially around the shaft 50. The first bearing 58 is disposed between the first and second extremities 52 and 54 of the shaft 50 such that the first bearing 58 cooperates with the axial bore 42 of the hub 40 for supporting the hub 40 relative to the shaft 50. A second bearing 60 is disposed coaxially around the shaft 50. The second bearing 60 is disposed between the first and second extremities 52 and 54 of the shaft 50 and is spaced axially from the first bearing 58 such that the second bearing 60 cooperates with the axial bore 42 of the hub 40 for supporting the hub 40 relative to the shaft 50.

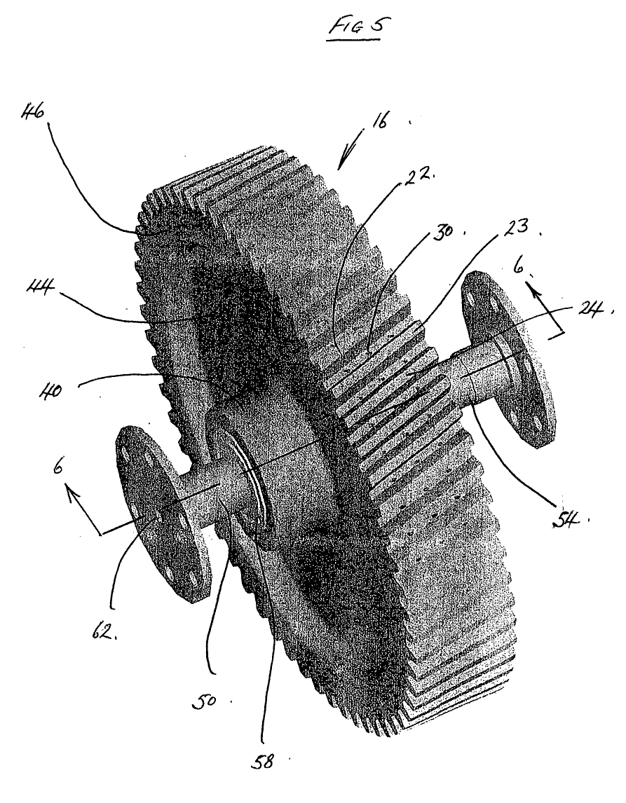

FIG. 5 is a similar view to that shown in FIG. 4 but shows the shaft 50 assembled within the hub 40 of the gear 16.

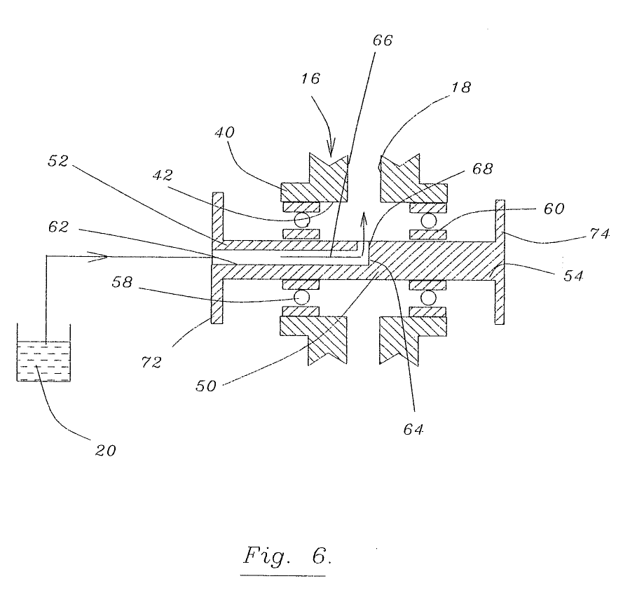

FIG. 6 is a sectional view taken on the line 6-6 of FIG. 5. As shown in FIG. 6, a conduit 62 has a termination 64 which is disposed adjacent to the hub 40, the termination 64 being disposed between the first and second bearings 58 and 60 respectively. The conduit 62 extends through the shaft 50 towards the hub 40 for supplying the lubricant L from the source 20 of the lubricant L to the hub 40. The arrangement is such that lubricant L flows as indicated by the arrow 66 from at least one of the extremities 52 and 54 of the shaft 50 through the conduit 62 towards the termination 64 of the conduit 62.

As shown in FIG. 6, the shaft 50 defines a cross bore 68 which extends from the termination 64 of the conduit 62 so that the flow of lubricant L as indicated by the arrow 66 is guided from the termination 64 through the cross bore 68 into the axial bore 42 of the hub 40.

As shown in FIG. 6, the shaft 50 further includes a first flange 72 secured to the first extremity 52 of the shaft 50. A second flange 74 is secured to the second extremity 54 of the shaft 50.

As shown in FIG. 2, the internal cavity 18 is of disc shaped configuration. The cavity 18 extends coaxially within the intermediate portion 44 for permitting flow of lubricant L, as indicated by the arrow 32, outwardly from the axial bore 42 of the hub 40 through the disc shaped cavity 18 towards the peripheral portion 46.

The disc shaped cavity 18 permits flow of lubricant L outwardly therethrough from the axial bore 42 of the hub 40 to the channel 26 by centrifugal force as indicated by the arrow 32, so that lubricant L is supplied centrifugally through the channel 26 for lubricating the intermeshing gear teeth 12.

The present invention also includes a method of manufacturing the gear 16 of the lubrication system 14. The method includes the step of casting the gear 16 as a metal casting.

FIG. 7 is a perspective view of a first foam pattern used in the step of casting the gear 16 shown in FIGS. 1-6. As shown in FIG. 7, the step of casting the gear 16 includes the substeps of generating the first foam pattern generally designated 78 of a first side 80 of the gear 16 shown in FIG. 2.

The first foam pattern 78 includes a first side 82 of the hub 40 shown in FIG. 2, a first side 84 of the intermediate portion 44, a first side 86 of the peripheral portion 46 and a first side 88 of the plurality of gear teeth 22-24 shown in FIG. 2.

The substep also includes generating a second foam pattern generally designated 90 of a second side 92 of the gear 16 as shown in FIG. 2. The second side 92 has a second side 94 of the replica of the hub 40, a second side 96 of the replica or former of the intermediate portion 44, a second side 98 of the peripheral portion 46 and a second side 100 of the plurality of gear teeth 22-24.

Additionally, the substep includes generating a third foam pattern generally designated 102 of a gear ring 104 of the gear 16. The gear ring 104 defines or is a former for a central part 106 of the plurality of gear teeth 22-24 as shown in FIG. 2. The third pattern 102 also defines a coaxial disc shaped cavity 18 which corresponds to the formed cavity 18 shown in FIG. 2. The third foam pattern 102 has a first and a second side 108 and 110 respectively. The third pattern 102 defines on at least one side 110 thereof a notch 112 disposed between adjacent parts of the gear teeth 22-23.

The substep next includes coaxially aligning the first, second and third foam patterns 78, 90 and 102 such that the third foam pattern 102 is disposed between the first and second patterns 78 and 90.

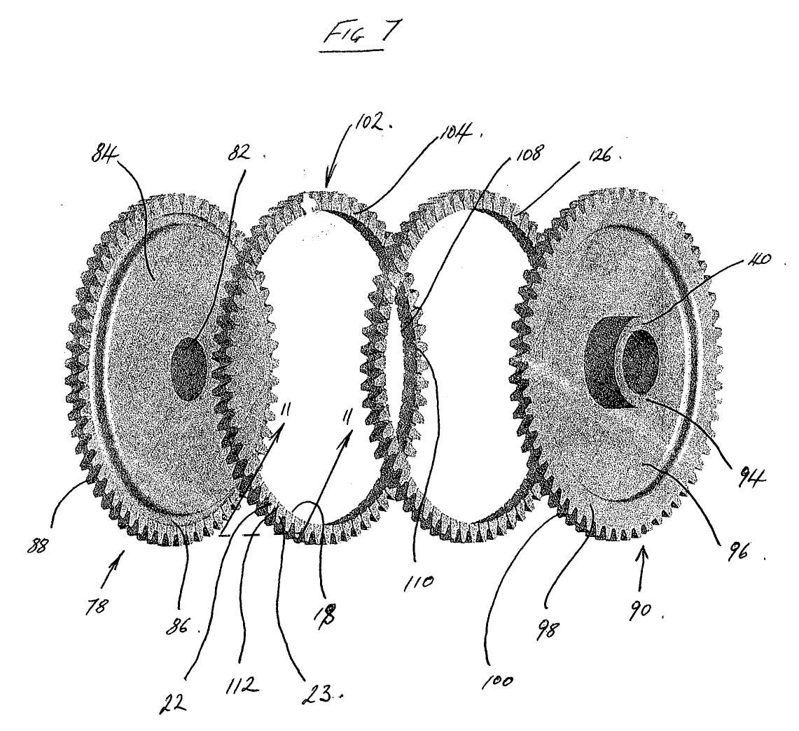

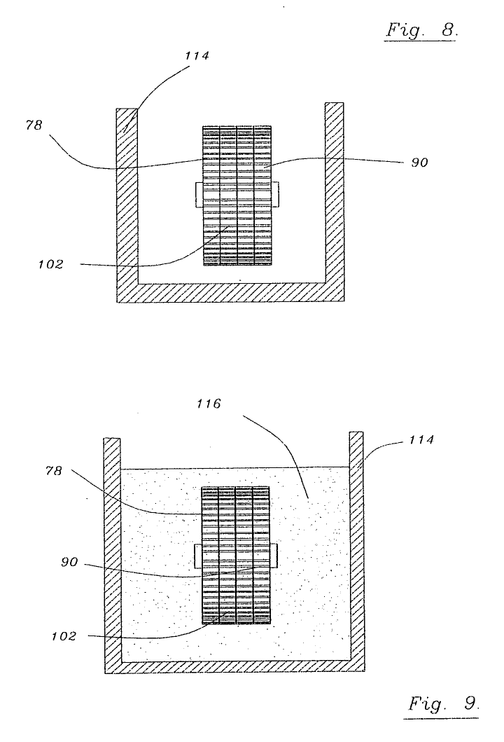

FIG. 8 is a side elevational view showing a casting box 114. As shown in FIG. 8, the substep next includes placing the combined foam patterns 78, 90 and 102 within the casting box 114.

FIG. 9 is a similar view to that shown in FIG. 8 but shows the next substep of filling the casting box 114 with casting sand mixed with resin 116 such that the sand 116 fills the cavity 18 and the notch 112 and so that the sand 116 surrounds the combined patterns 78, 90 and 102.

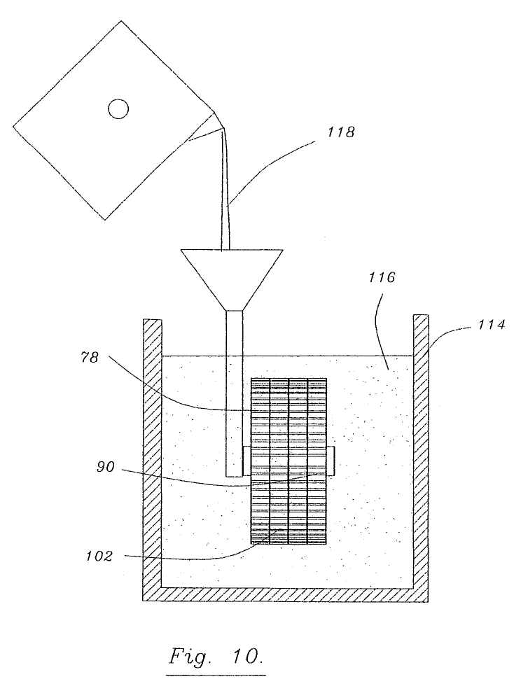

FIG. 10 is a similar view to that shown in FIG. 9 but shows the next substep of pouring molten metal 118 into the casting box 114 such that the molten metal 118 burns the foam patterns 78, 90 and 102 to generate the cast metal gear 16.

The substep further includes removing the sand 116 from around the cast metal gear 16 and of removing the sand 116 disposed within the disc shaped cavity 18 and from the notch 112 so that the cast metal gear 16 defines a corresponding disc shaped cavity 18 and a channel 26 corresponding to the notch 112. The arrangement is such that in use of the cast metal gear 16, lubricant L flows centrifugally as indicated by the arrow 32 shown in FIG. 2 from the axial bore 42 of the hub 40 through the disc shaped cavity 18 and through the channel 26 for lubricating the intermeshing gear teeth 22-24 of the cast metal gear 16.

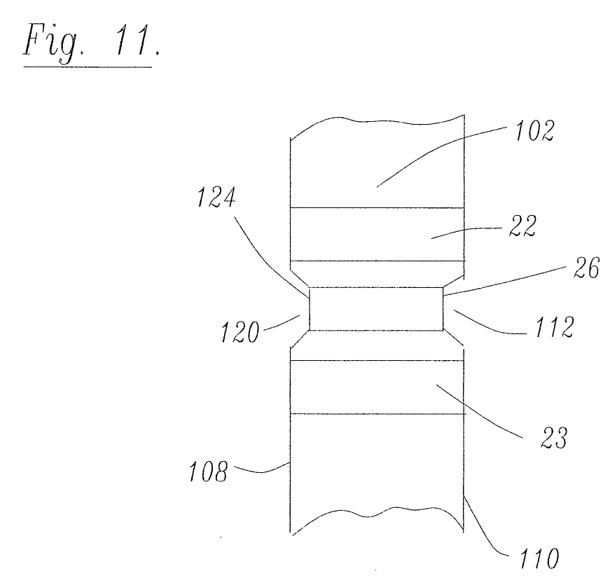

FIG. 11 is an enlarged view taken on the line 11-11 of FIG. 7. As shown in FIG. 11, the step of generating the third foam pattern 102 includes forming the third foam pattern 102 such that the third foam pattern 102 defines a notch 120 on the first side 108 of the third foam pattern 102, the notch 120 being disposed between adjacent teeth 22 and 23.

The third foam pattern 102 is formed such that the third foam pattern 102 defines the notch 112 on the second side 110 of the third foam pattern 102, the notch 112 being disposed between adjacent teeth 22 and 23 so that the resultant cast metal gear 16 defines a corresponding first channel 26 and second channel 124 both disposed between adjacent gear teeth 22 and 23. Moreover, the channels 26 and 124 are spaced axially relative to each other.

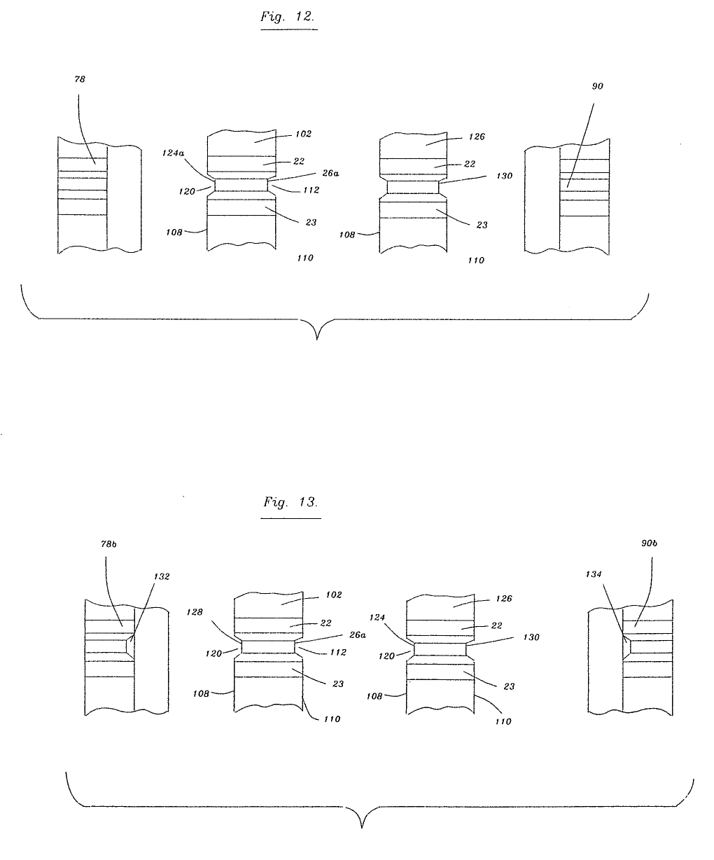

FIG. 12 is perspective view of an alternative method of fabricating a gear 16. As shown in FIG. 12, the alternative method includes the further step of generating a fourth foam pattern 126 similar in shape to the third pattern 102 so that when the patterns 78, 90, 102 and 126 are combined the fourth pattern 126 is disposed between the third and second patterns 102 and 90 respectively. The arrangement is such that the resultant cast metal gear 16 defines corresponding first and second channels 26a and 124a respectively and a third channel 130 All of the channels 26a, 124a and 130 are disposed between adjacent gear teeth 22 and 23. The channels 26a, 124 and 130 are spaced axially relative to each other.

FIG. 13 is a similar view to that shown in FIG. 12 but shows another method according to the present invention. As shown in FIG. 13, the step of generating a first foam pattern 78b includes forming a cut out 132 for alignment with the notch 120 of the third portion 102 so that the combined cut out 132 and notch 120 correspond with the resultant channel 124.

Also, the step of forming the second foam pattern 90b includes forming a groove 134 for alignment with the notch 130 of the fourth portion 126 so that the combined groove 134 and notch 130 correspond with a resultant third channel 130 as shown in FIG. 4.

In operation of the lubrication system according to the present invention, lubricant L flows from the source 20 through the conduit 62, cross bore 68, axial bore 42, cavity 18 and channel 26 for supplying lubricant L between adjacent gear teeth 22 and 23. The gear 16 is generated with one channel 26 between adjacent teeth 22 and 23. Alternatively, two channels 26 and 124 are provided between adjacent gear teeth 22 and 23. Preferably, three channels 26, 124 and 130 are provided between adjacent teeth 22 and 23.

In the preferred embodiment of the present invention, three lubricating channels 26, 124 and 130 are formed between each of the adjacent gear teeth as shown in FIG. 4.

The present invention provides a unique and improved arrangement for supplying adequate lubrication between intermeshing gear teeth.

What is claimed is:

1. In a gear apparatus having intermeshing gear teeth, a lubrication system for supplying lubricant between said intermeshing gear teeth, said lubrication system comprising:
a gear defining an internal cavity connected to a source of the lubricant;
said gear defining a plurality of spaced circumferentially disposed gear teeth;
said plurality of gear teeth including:
a first gear tooth and a second gear tooth disposed adjacent to said first gear tooth;
said gear defining a channel having a first and a second end, said first end of said channel being connected to said internal cavity; and
said second end of said channel being disposed between said first and second gear teeth such that when said internal cavity is connected to said source of the lubricant, lubricant flows from said cavity through said first end of said channel to said second end of said channel for distributing the lubricant between said adjacent gear teeth so that the intermeshing gear teeth are lubricated.

2. A lubrication system as set forth in claim 1 wherein
said gear is a gear wheel for driving a drying cylinder of a paper making machine.

3. A lubrication system as set forth in claim 1 wherein
said gear includes:
a hub which defines an axial bore;
an intermediate portion disposed coaxially around said hub;
a peripheral portion disposed coaxially around said intermediate portion, said peripheral portion having an outer surface;
said outer surface of said peripheral portion defining said plurality of gear teeth such that said plurality of gear teeth extend outwardly away from said hub.

4. A lubrication system as set forth in claim 3 further including:
an elongate shaft having a first and a second extremity, said shaft extending coaxially through said axial bore of said hub such that said gear is bearingly supported by said shaft for rotation of said gear relative to said shaft.

5. A lubrication system as set forth in claim 4 wherein
said shaft includes:
a first bearing disposed coaxially around said shaft, said first bearing being disposed between said first and second extremities of said shaft such that said first bearing cooperates with said axial bore of said hub for supporting said hub relative to said shaft;
a second bearing disposed coaxially around said shaft, said second bearing being disposed between said first and second extremities of said shaft and spaced axially from said first bearing such that said second bearing cooperates with said axial bore of said hub for supporting said hub relative to said shaft.

6. A lubrication system as set forth in claim 5 wherein
said shaft defines a conduit having a termination disposed adjacent to said hub, said termination being disposed between said first and second bearings, said conduit extending through said shaft towards said hub for supplying the lubricant from the source of the lubricant to said hub, the arrangement being such that lubricant flows from at least one of said extremities of said shaft through said conduit towards said termination of said conduit.

7. A lubrication system as set forth in claim 6 wherein
said shaft defines a cross bore which extends from said termination of said conduit so that the flow of lubricant is guided from said termination through said cross bore into said axial bore of said hub.

8. A lubrication system as set forth in claim 4 wherein
said shaft further includes:
a first flange secured to said first extremity of said shaft;
a second flange secured to said second extremity of said shaft.

9. A lubrication system as set forth in claim 3 wherein
said internal cavity is of disc shaped configuration, said cavity extending coaxially within said intermediate portion for permitting flow of lubricant outwardly from said axial bore of said hub through said disc shaped cavity towards said peripheral portion.

10. A lubrication system as set forth in claim 9 wherein
said disc shaped cavity permits flow of lubricant outwardly therethrough from said axial bore of said hub to said channel by centrifugal force so that lubricant is supplied centrifugally through said channel for lubricating the intermeshing gear teeth.

11. A method of manufacturing a gear of a lubrication system as set forth in claim 1, said method comprising the step of:
casting the gear as a metal casting;
the step of casting the gear including the substeps of:
generating a first foam pattern of a first side of the gear, the first side having a first side of the hub, intermediate portion, peripheral portion and plurality of gear teeth;
generating a second foam pattern of a second side of the gear, the second side having a second side of the hub, intermediate portion, peripheral portion and plurality of gear teeth;
generating a third foam pattern of a gear ring of the gear, the gear ring defining a part of the plurality of gear teeth, the third pattern also defining a coaxial disc shaped cavity, the third foam pattern defining on at least one side thereof a notch disposed between adjacent parts of the gear teeth;
coaxially aligning the first, second and third foam patterns such that said third foam pattern is disposed between said first and second patterns;
placing the combined foam patterns within a casting box;
filling the casting box with casting sand mixed with resin such that the sand fills the cavity and the notch and so that the sand surrounds the combined patterns;
pouring molten metal into the casting box such that the cast metal burns the foam patterns to generate a cast metal gear;
removing the sand from around the cast metal gear and removing the sand disposed within the disc shaped cavity and the notch so that the cast metal gear defines a corresponding disc shaped cavity and a channel corresponding to the notch such that in use of the cast metal gear, lubricant flows centrifugally from the axial bore of the hub through the disc shaped cavity and through the channel for lubricating the intermeshing teeth of the cast metal gear.

12. A method as set forth in claim 11 wherein the step of generating the third foam pattern includes:
forming the third foam pattern such that the third foam pattern defines a notch on a first side of the third foam pattern, the notch being disposed between adjacent teeth;
forming the third foam pattern such that the third foam pattern defines another notch on a second side of the third foam pattern, the another notch being disposed between adjacent teeth so that the resultant cast metal gear defines a corresponding first and second channel between adjacent gear teeth, the channels being spaced axially relative to each other.

13. A method as set forth in claim 12 including the further step of:
generating a fourth foam pattern similar in shape to the third pattern so that when the patterns are combined, the fourth pattern is disposed between the third and second patterns such that the resultant cast metal gear defines corresponding first second and third channels between adjacent gear teeth, the channels being spaced axially relative to each other.

14. A lubrication system as set forth in claim 11 wherein the step of generating the first foam pattern includes:
forming a cut out for alignment with the corresponding notch of the third portion so that the combined cut out and notch generate the resultant channel.

15. A lubrication system as set forth in claim 12 wherein the step of generating the second foam pattern includes:
forming a groove for alignment with the another notch of the third portion so that the combined groove and corresponding notch of the third pattern generate a resultant second channel.

16. In a gear apparatus having intermeshing gear teeth, a lubrication system for supplying lubricant between said intermeshing gear teeth, said lubrication system comprising:
a gear defining an internal cavity connected to a source of the lubricant;
said gear defining a plurality of spaced circumferentially disposed gear teeth;
said plurality of gear teeth including:
a first gear tooth and a second gear tooth disposed adjacent to said first gear tooth;
said gear defining a channel having a first and a second end, said first end of said channel being connected to said internal cavity;
said second end of said channel being disposed between said first and second gear teeth such that when said internal cavity is connected to said source of the lubricant, lubricant flows from said cavity through said first end of said channel to said second end of said channel for distributing the lubricant between said adjacent gear teeth so that the intermeshing gear teeth are lubricated; and
said cavity permitting flow of lubricant outwardly therethrough by centrifugal force to said channel so that lubricant is supplied centrifugally through said channel for lubricating the intermeshing gear teeth.

17. In a gear apparatus having intermeshing gear teeth, a lubrication system for supplying lubricant between said intermeshing gear teeth, said lubrication system comprising:
a gear defining an internal cavity connected to a source of the lubricant;
said gear defining a plurality of spaced circumferentially disposed gear teeth;
said plurality of gear teeth including:
a first gear tooth and a second gear tooth disposed adjacent to said first gear tooth;
said gear defining a channel having a first and a second end, said first end of said channel being connected to said internal cavity;
said second end of said channel being disposed between said first and second gear teeth such that when said internal cavity is connected to said source of the lubricant, lubricant flows from said cavity through said first end of said channel to said second end of said channel for distributing the lubricant between said adjacent gear teeth so that the intermeshing gear teeth are lubricated;
said gear being a gear wheel for driving a drying cylinder of a paper making machine;
said gear including:
a hub which defines an axial bore;
an intermediate portion disposed coaxially around said hub;
a peripheral portion disposed coaxially around said intermediate portion, said peripheral portion having an outer surface;
said outer surface of said peripheral portion defining said plurality of teeth such that said plurality of gear teeth extend outwardly away from said hub;
said lubrication system further including:
an elongate shaft having a first and a second extremity, said shaft extending coaxially through said axial bore of said hub such that said gear is bearingly supported by said shaft for rotation of said gear relative to said shaft;
said shaft including:
a first bearing disposed coaxially around said shaft, said first bearing being disposed between said first and second extremities of said shaft such that said first bearing cooperates with said axial bore of said hub for supporting said hub relative to said shaft;
a second bearing disposed coaxially around said shaft, said second bearing being disposed between said first and second extremities of said shaft and spaced axially from said first bearing such that said second bearing cooperates with said axial bore of said hub for supporting said hub relative to said shaft;
said shaft defining a conduit having a termination disposed adjacent to said hub, said termination being disposed between said first and second bearings, said conduit extending through said shaft towards said hub for supplying the lubricant from the source of the lubricant to said hub, the arrangement being such that lubricant flows from at least one of said extremities of said shaft through said conduit towards said termination of said conduit;
said shaft defining a cross bore which extends from said termination of said conduit so that the flow of lubricant is guided from said termination through said cross bore into said axial bore of said hub;
said shaft further including:
a first flange secured to said first extremity of said shaft;
a second flange secured to said second extremity of said shaft;
said internal cavity is of disc shaped configuration, said cavity extending coaxially within said intermediate portion for permitting flow of lubricant outwardly from said axial bore of said hub through said disc shaped cavity towards said peripheral portion; and
said disc shaped cavity permitting flow of lubricant outwardly therethrough by centrifugal force from said axial bore of said hub to said channel so that lubricant is supplied centrifugally through said channel for lubricating the intermeshing gear teeth.
